(19) United States
(12) Patent Application Publication
(10) Pub. No.: US 2025/0383044 A1
(43) Pub. Date: Dec. 18, 2025

(54) DOME CAMERA WITH EASY GIMBAL OPERATION

(71) Applicant: IDIS CO., LTD., Daejeon (KR)

(72) Inventors: Min Shic SHIN, Seongnam-si (KR); Jin Seong CHOI, Seongnam-si (KR)

(73) Assignee: IDIS CO., LTD., Daejeon (KR)

(21) Appl. No.: 19/192,424

(22) Filed: Apr. 29, 2025

(30) Foreign Application Priority Data
Jun. 12, 2024 (KR) 10-2024-0076222

(51) Int. Cl. F16M 11/12; G03B 17/12; G03B 17/56; H04N 23/695

(52) U.S. Cl. CPC F16M 11/123; F16M 11/126; G03B 17/12; G03B 17/561; H04N 23/695

(57) ABSTRACT

The present invention relates to a dome camera with easy gimbal operation in which a gimbal operation may be smoothly and continuously driven to prevent generation of a blind spot and also allows a user to more easily adjust a surveillance direction.

### CROSS-REFERENCE TO RELATED APPLICATION(S)

This application claims priority from Korean Patent Application No. 10-2024-0076222, filed on Jun. 12, 2024 in the Korean Intellectual Property Office, the disclosure of which is incorporated herein by reference in its entirety.

### BACKGROUND

### 1. Field

The following description relates to a dome camera, and more particularly, to a dome camera with easy gimbal operation.

### 2. Description of Related Art

A dome camera is a camera of which a surveillance direction can be adjusted and which includes a dome cover, which is a transparent dome (hemisphere)-shaped window, to protect the camera from the outside and also allow the camera to capture an image of an entire region even when a pan/tilt operation is performed.

A dome camera may have a horizontal rotation (pan) function, a vertical rotation (tilt) function, and a zoom function for adjusting a magnification, and these functions are called PTZ and used in various products such as a closed-circuit television (CCTV) and video conference cameras, lighting apparatuses, and the like.

In a general dome camera, a surveillance direction of the camera is manually adjusted through an internal gimbal operation, and in a speed dome camera, a surveillance direction of the camera is automatically or remotely adjusted using a motor and a power transmission device.

When a surveillance direction is manually adjusted, there are many cases in which a sawtooth structure having a click sensation is used because a fixing force for properly fixing the surveillance direction is required after a gimbal adjustment is performed, and since a gimbal cannot be positioned between sawteeth, there is a problem that a blind spot is generated and a desired place cannot be viewed.

Accordingly, the present inventor has conducted research on a dome camera with easy gimbal operation which allows a smooth and continuous gimbal operation to be performed to prevent generation of a blind spot and also allows a user to adjust a surveillance direction more easily.

### RELATED ART

### Patent Document

Korean Registered Patent No. 10-1777582 (Announced on Sep. 13, 2017)

### SUMMARY

Embodiments of the present invention are directed to providing a dome camera with easy gimbal operation which allows a smooth and continuous gimbal operation to be performed to prevent generation of a blind spot and also allows a user to adjust a surveillance direction more easily.

In accordance with one aspect of the present invention, there is provided a dome camera with easy gimbal operation, which includes a lens module, a housing in which the lens module is accommodated and mounted to protect the lens module from the outside, a dome cover mounted to protrude from a front surface of the housing and formed of a transparent material not to block a field of view of the lens module accommodated and mounted in the housing, a pan driver which performs a pan operation of the lens module, and a pan O-ring which allows the lens module, of which the pan operation is driven by the pan driver, to pan smoothly.

In accordance with an additional aspect of the present invention, the dome camera with easy gimbal operation may further include a tilt driver which performs a tilt operation of the lens module and a tilt O-ring which allows the lens module, of which the tilt operation is driven by the tilt driver, to tilt smoothly.

In accordance with an additional aspect of the present invention, the dome camera with easy gimbal operation may further include a rotation driver which performs a rotation operation of the lens module and a rotation O-ring which allows the lens module, of which the rotation operation is driven by the rotation driver, to rotate smoothly.

In accordance with an additional aspect of the present invention, a surface of the pan O-ring may be coated with urethane.

In accordance with an additional aspect of the present invention, a surface of the tilt O-ring may be coated with urethane.

In accordance with an additional aspect of the present invention, a surface of the rotation O-ring may be coated with urethane.

### BRIEF DESCRIPTION OF THE DRAWINGS

FIG. 1 shows perspective views illustrating a configuration of a dome camera with easy gimbal operation according to one embodiment of the present invention.

FIG. 2 is a perspective view for describing a pan operation of a lens module of the dome camera with easy gimbal operation according to the present invention.

FIG. 3 is a cross-sectional view illustrating a pan O-ring installed to allow the pan operation of the lens module of the dome camera with easy gimbal operation to be easily performed according to the present invention.

FIG. 4 is a perspective view for describing a tilt operation of the lens module of the dome camera with easy gimbal operation according to the present invention.

FIG. 5 is a cross-sectional view illustrating a tilt O-ring installed to allow the tilt operation of the lens module of the dome camera with easy gimbal operation to be easily performed according to the present invention.

FIG. 6 is a perspective view for describing a rotation operation of the lens module of the dome camera with easy gimbal operation according to the present invention.

FIG. 7 is a cross-sectional view illustrating a rotation O-ring installed to allow the rotation operation of the lens module of the dome camera with easy gimbal operation to be easily performed according to the present invention.

### DETAILED DESCRIPTION

Hereinafter, in order to facilitate understanding and embodiment by those skilled in the art, the present invention will be described in detail by describing exemplary embodiments with reference to the accompanying drawings. Although specific embodiments are illustrated in the drawings and detailed explanations are described, the embodiments are not intended to limit embodiments of the present invention to the specific forms.

In the description of the invention, when it is determined that detailed descriptions of related well-known functions or configurations unnecessarily obscure the gist of the invention, the detailed descriptions thereof will be omitted.

It will be understood that when a first component is referred to as being “connected” or “coupled” to a second component, the first component may be directly connected or coupled to the second component, or a third component may be interposed therebetween.

In contrast, it will be understood that when a first component is referred to as being “directly connected” or “directly coupled” to a second component, there are no intervening components.

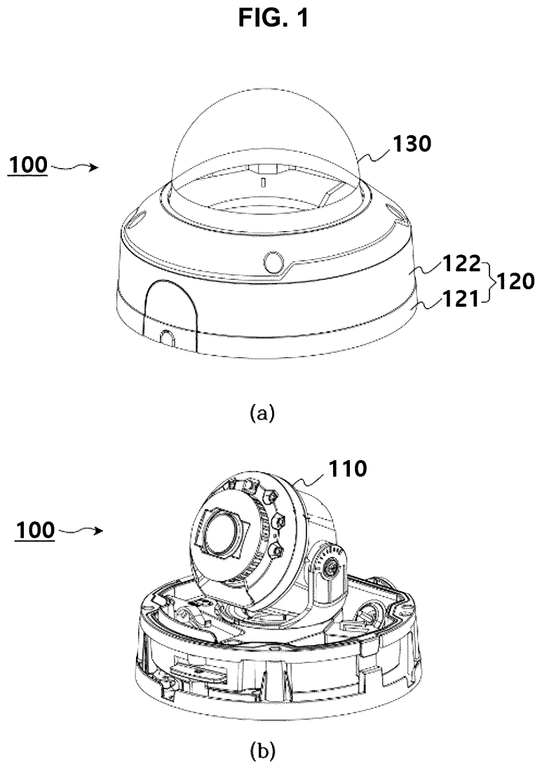

FIG. 1 shows perspective views illustrating a configuration of a dome camera with easy gimbal operation according to one embodiment of the present invention. As illustrated in FIG. 1, a dome camera 100 with easy gimbal operation according to the present invention includes a lens module 110, a housing 120, and a dome cover 130.

The lens module 110 includes at least one optical lens, a lens holder which fixes the optical lens, an image sensor which converts an optical signal of an image captured by the optical lens into an electric signal, and a protection cover which protects these components from the outside.

The lens module 110 is accommodated and mounted in the housing 120 and protected from the outside. For example, the housing 120 may include a rear housing 121 and a front housing 122 and may be formed of an insulating material such as plastic.

The dome cover 130 may be mounted to protrude from a front surface of the housing 120 and formed of a transparent material not to block a field of view of the lens module 110 accommodated and mounted in the housing 120.

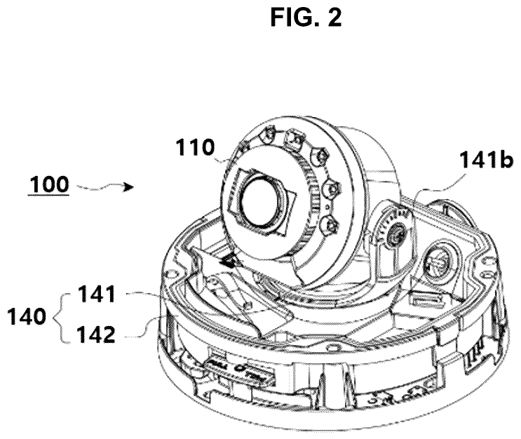

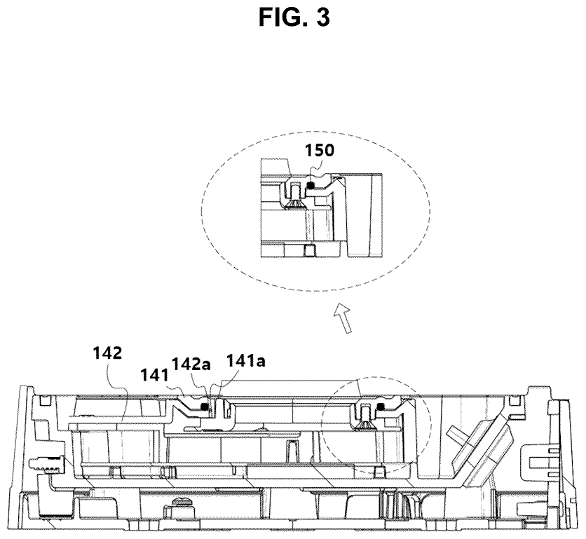

FIG. 2 is a perspective view for describing a pan operation of the lens module of the dome camera with easy gimbal operation according to the present invention, and FIG. 3 is a cross-sectional view illustrating a pan O-ring installed to allow the pan operation of the lens module of the dome camera with easy gimbal operation to be easily performed according to the present invention.

As illustrated in FIGS. 2 and 3, the dome camera 100 with easy gimbal operation according to the present embodiment may include a pan driver 140 and a pan O-ring 150 for easily performing the pan operation of the lens module 110.

The pan driver 140 may be a component for the pan operation of the lens module 110 and include a bracket 141 which fixedly supports the lens module 110 and a base body 142 on which a cylindrical lower portion 141a of the bracket 141 is axially installed.

When a user holds the bracket 141, of which the cylindrical lower portion 141a is axially installed on the base body 142, in their hand and horizontally rotates the bracket 141 left and right, the bracket 141 is horizontally rotated left and right, and the lens module 110 fixedly supported by the bracket 141 horizontally rotated left and right is horizontally rotated left and right with the bracket 141 to perform the pan operation.

In this case, as an outer circumference of the cylindrical lower portion 141a of the bracket 141, of which the cylindrical lower portion 141a is axially installed on the base body 142, and an inner circumference of an axial installation groove 142a of the base body 142 coupled to the outer circumference to correspond to the outer circumference are implemented as sawtooth structures, the lens module 110 may be implemented such that a posture thereof is maintained without shaking in a state in which the lens module 110 is controlled for the pan operation even when the user manually controls the lens module 110 for the pan operation.

The pan O-ring 150 allows the lens module 110, of which the pan operation is driven by the pan driver 140, to pan smoothly. For example, the pan O-ring 150 may be installed on a contact portion of the base body 142 and the bracket 141 axially installed thereon. In this case, as a surface of the pan O-ring 150 is coated with urethane, the lens module 110 driven for the pan operation may be implemented to pan more smoothly.

With this implementation, in the present invention, when the pan operation of the lens module 110 is driven, the pan operation may be smoothly and continuously driven due to the pan O-ring 150, generation of a blind spot may be prevented, the user may also more easily adjust a surveillance direction, and thus the surveillance performance and user convenience can be improved.

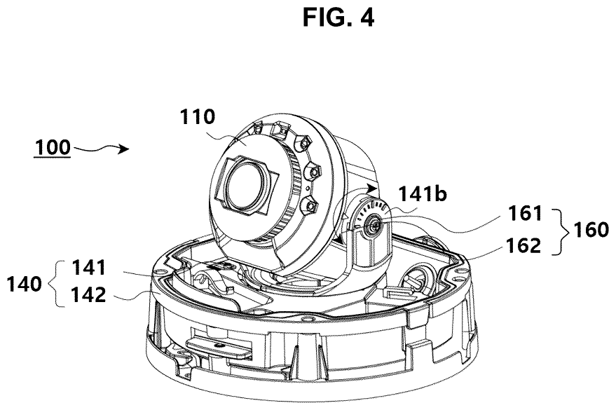

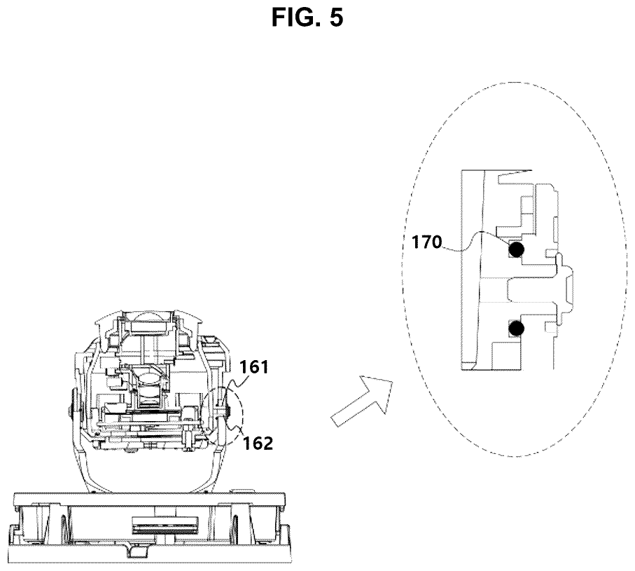

FIG. 4 is a perspective view for describing a tilt operation of the lens module of the dome camera with easy gimbal operation according to the present invention, and FIG. 5 is a cross-sectional view illustrating a tilt O-ring installed to allow the tilt operation of the lens module of the dome camera with easy gimbal operation to be easily performed according to the present invention.

As illustrated in FIGS. 4 and 5, the dome camera 100 with easy gimbal operation according to the present embodiment may include a tilt driver 160 and a tilt O-ring 170 for easily performing the tilt operation of the lens module 110.

The tilt driver 160 may be a component for the tilt operation of the lens module 110 and include circular grooves 161 formed in a pair of protrusions 141b protruding upward from the bracket 141 which fixedly supports the lens module 110 and a pair of lens module coupling parts 162 of which one ends are axially installed in the circular grooves 161 and the other ends are coupled to outer circumferences of both sides of the lens module 110 and which vertically rotate upward and downward.

When the user holds the lens module 110, of which the outer circumferences are coupled to the pair of lens module coupling parts 162 axially installed in the circular grooves 161 formed in the pair of protrusions 141b protruding upward from the bracket 141, in their hand and vertically rotates the lens module 110 upward and downward, the lens module 110 is driven to tilt.

In this case, as inner circumferences of the circular grooves 161 formed in the pair of protrusions 141b protruding upward from the bracket 141 and outer circumferences of one ends of the pair of lens module coupling parts 162 axially installed to correspond thereto are implemented as sawtooth structures, the lens module 110 may be implemented such that a posture thereof is maintained without shaking in a state in which the lens module 110 is controlled for the tilt operation even when the user manually controls the lens module 110 for the tilt operation.

The tilt O-ring 170 allows the lens module 110, of which the tilt operation is driven by the tilt driver 160, to tilt smoothly. For example, the tilt O-ring 170 may be installed on a contact portion of each of the circular grooves 161 formed in the pair of protrusions 141b protruding upward from the bracket 141 and the lens module coupling parts 162 axially installed thereon. In this case, as a surface of the tilt O-ring 170 is coated with urethane, the lens module 110 driven for the tilt operation may be implemented to tilt more smoothly.

With this implementation, in the present invention, when the tilt operation of the lens module 110 is driven, the tilt operation may be smoothly and continuously driven due to the tilt O-ring 170, generation of a blind spot may be prevented, the user may also more easily adjust a surveillance direction, and thus the surveillance performance and user convenience can be improved.

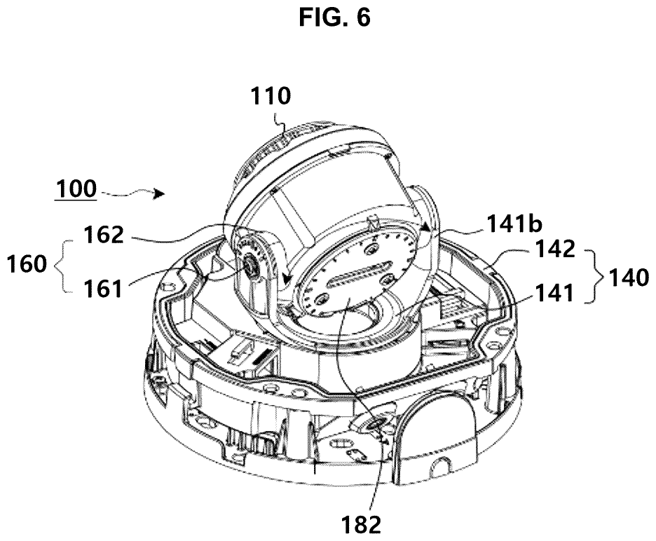

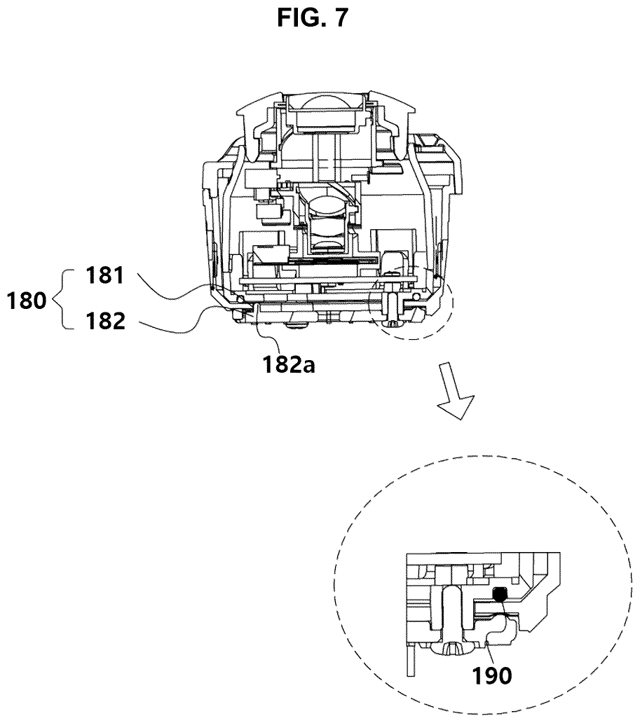

FIG. 6 is a perspective view for describing a rotation operation of the lens module of the dome camera with easy gimbal operation according to the present invention, and FIG. 7 is a cross-sectional view illustrating a rotation O-ring installed to allow the rotation operation of the lens module of the dome camera with easy gimbal operation to be easily performed according to the present invention.

As illustrated in FIGS. 6 and 7, the dome camera 100 with easy gimbal operation according to the present embodiment may include a rotation driver 180 and a rotation O-ring 190 for easily performing the rotation operation of the lens module 110.

The rotation driver 180 may be a component for the rotation operation of the lens module 110 and include a rear coupling groove 181 formed in a rear surface of the housing 120 formed to externally surround the protection cover, which protects the lens module 110 from the outside, and a rear bracket 182 which is coupled to a rear surface of the protection cover of the lens module 110 through screw coupling or the like and in which an annular protrusion 182a protruding from a front surface of the rear bracket 182 is coupled to the rear coupling groove 181 and rotated with the lens module 110.

When the user holds the lens module 110 in their hand and rotates the lens module 110 left and right, the lens module 110 and the rear bracket 182 fixedly coupled thereto are rotated in the rear coupling groove 181, so that the lens module 110 is driven for the rotation operation.

In this case, as an inner circumference of the rear coupling groove 181 formed in the rear surface of the housing 120 formed to externally surround the protection cover, which protects the lens module 110 from the outside, and an outer circumference of the annular protrusion 182a of the rear bracket 182 are implemented as sawtooth structures, the lens module 110 may be implemented such that a posture thereof is maintained without shaking in a state in which the lens module 110 is controlled for the rotation operation even when the user manually controls the lens module 110 for the rotation operation.

The rotation O-ring 190 allows the lens module 110, of which the rotation operation is driven by the rotation driver 180, to rotate smoothly. For example, the rotation O-ring 190 may be installed on a contact portion of an outer side of the rear surface of the protection cover, which protects the lens module 110 from the outside, and an inner side of the rear surface of the housing 120 formed to surround the protection cover from the outside. In this case, as a surface of the rotation O-ring 190 is coated with urethane, the lens module 110 driven for the rotation operation may be implemented to rotate more smoothly.

With this implementation, in the present invention, when the rotation operation of the lens module 110 is driven, the rotation operation may be smoothly and continuously driven due to the rotation O-ring 190, and thus the user convenience can be improved.

As described above, in the present invention, since a gimbal operation can be smoothly and continuously driven to prevent generation of a blind spot, and a user can also adjust a surveillance direction more easily, the surveillance performance and user convenience can be improved.

In the present invention, since a gimbal operation can be smoothly and continuously driven to prevent generation of a blind spot and a user can also adjust a surveillance direction more easily, there is an effect of improving the surveillance performance and user convenience.

Various embodiments disclosed in this specification and drawings are only specific examples to aid in understanding of the invention and are not intended to limit the scope of various embodiments of the present invention.

Accordingly, the scope of various embodiments of the present invention should not be limited by the above-described embodiments, and all changes or modifications derived from the technical ideas of various embodiments of the present invention should be construed as being included in the scope of various embodiments of the present invention.

### INDUSTRIAL APPLICABILITY

The present invention can be industrially used in the technology field related to a dome camera and the application technology field thereof.

What is claimed is:

1. A dome camera with easy gimbal operation, comprising:
a lens module;
a housing in which the lens module is accommodated and mounted to protect the lens module from an outside;
a dome cover mounted to protrude from a front surface of the housing and formed of a transparent material not to block a field of view of the lens module accommodated and mounted in the housing;
a pan driver which performs a pan operation of the lens module; and
a pan O-ring which allows the lens module, of which the pan operation is driven by the pan driver, to pan smoothly.

2. The dome camera of claim 1, further comprising:
a tilt driver which performs a tilt operation of the lens module; and
a tilt O-ring which allows the lens module, of which the tilt operation is driven by the tilt driver, to tilt smoothly.

3. The dome camera of claim 2, further comprising:
a rotation driver which performs a rotation operation of the lens module; and
a rotation O-ring which allows the lens module, of which the rotation operation is driven by the rotation driver, to rotate smoothly.

4. The dome camera of claim 3, wherein a surface of the pan O-ring is coated with urethane.

5. The dome camera of claim 3, wherein a surface of the tilt O-ring is coated with urethane.

6. The dome camera of claim 3, wherein a surface of the rotation O-ring is coated with urethane.
